(19) United States
(12) Patent Application Publication
(10) Pub. No.: US 2013/0322668 A1
(43) Pub. Date: Dec. 5, 2013

(54) ADAPTIVE HEARING ASSISTANCE DEVICE USING PLURAL ENVIRONMENT DETECTION AND CLASSIFICAITON

(71) Applicant: STARKEY LABORATORIES, INC., Eden Prairie, MN (US)

(72) Inventors: Tao Zhang, Eden Prairie, MN (US); Martin McKinney, Minneapolis, MN (US)

(21) Appl. No.: 13/906,694

(22) Filed: May 31, 2013

Related U.S. Application Data
(60) Provisional application No. 61/654,436, filed on Jun. 1, 2012.

(51) Int. Cl. H04R 25/00

(52) U.S. Cl. CPC H04R 25/50
USPC 381/314

(57) ABSTRACT

Disclosed herein, among other things, are systems and methods for adaptive hearing assistance devices using plural environment detection and classification. One aspect of the present subject matter includes a method of operating a hearing assistance device for a wearer. Acoustic inputs are received and a plurality of acoustic environments are determined by performing signal processing in parallel based on the received acoustic inputs. According to various embodiments, an audiological parameter of the hearing assistance device is adjusted based the determined plurality of acoustic environments.

### CLAIM OF PRIORITY

The present application claims the benefit under 35 U.S.C. §119(e) of U.S. Provisional Patent Application 61/654,436, filed Jun. 1, 2012, the disclosure of which is hereby incorporated by reference herein in its entirety.

### TECHNICAL FIELD

This document relates generally to hearing assistance systems and more particularly to methods and apparatus for adaptive hearing assistance devices using plural environment detection and classification.

### BACKGROUND

Modern hearing assistance devices, such as hearing aids, are electronic instruments worn in or around the ear that compensate for hearing losses of hearing-impaired people by specially amplifying sound. Hearing aid (HA) wearers encounter many different acoustic environments in which they expect their hearing aids to improve their audibility and intelligibility. However, under different acoustic conditions, (e.g., babble noise, road noise, quiet, music), the algorithms and parameters in the hearing aid need to be optimized differently. The present subject matter is more robust for different acoustic conditions because it performs automatic classification and/or categorization of acoustic environments using different environment detection and classification methods to select parameters and/or algorithms for a current environment.

### SUMMARY

Disclosed herein, among other things, are systems and methods for adaptive hearing assistance devices using plural environment detection and classification. One aspect of the present subject matter includes a method of operating a hearing assistance device for a wearer. Acoustic inputs are received and a plurality of acoustic environments are determined by performing signal processing in parallel based on the received acoustic inputs. According to various embodiments, an audiological parameter of the hearing assistance device is adjusted based the determined plurality of acoustic environments using hearing assistance electronics.

One aspect of the present subject matter includes a hearing assistance system including a hearing assistance device for a user. The system includes a plurality of detectors configured to receive acoustic inputs and a signal processor configured to determine a plurality of acoustic environments in parallel using the acoustic inputs. According to various embodiments, the signal processor is configured to provide settings for the hearing assistance device for improved signal processing in the plurality of acoustic environments. The system also includes a receiver for playing sounds processed by the signal processor, in various embodiments.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a traditional system for classifying an acoustic environment for a hearing assistance device.

FIG. 2 illustrates a system for classifying a plurality of acoustic environments for a hearing assistance device, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device and it is understood that their use in the description is intended to demonstrate the present subject matter, but not in a limited or exclusive sense. Modern hearing aid designs are highly programmable and require innovative approaches to controlling the hearing aid. Such designs may also be wireless and may communicate with other devices having programmable controls to provide controllable functions or settings.

The embodiments described herein focus on, among other things, programmable hearing assistance devices. One component of a hearing aid system includes a processor. The processor provides, among other things, the ability to perform audio signal processing. In various embodiments, the processing system includes a controller or processor. The processor may be any type of processor including RISC, CISC, VLIW, MISC, OISC, and may include a microprocessor, microcontroller, and/or a Digital Signal Processor (“DSP”). In one embodiment, the processor communicates with an RF receiver and RF transmitter to transmit and receive wireless signals such as cellular, Bluetooth, and Wi-Fi signals. The processor may use short term memory to store operating instructions and help in the execution of the operating instructions such as the temporary storage of calculations and the like. The processor may also use non-transitory storage to read instructions, files, and other data that requires long term, non-volatile storage.

The audio signal processing includes audiological parameters that may be adjusted so as to enhance the sense of hearing for a patient. This adjustment of the audiological parameters is a tailoring (or fitting) of an audiological therapy for a specific patient. In tailoring, the patient is tested to obtain aural responses to various conditions. These responses are then used to determine which audiological parameters to adjust as well as the ranges of audiological parameter values that may be adjusted. Different brands of hearing aid may have different audiological parameters. This process of adjustment may be considered a programming of the hearing aid system. Different signal processing algorithms can be employed by the system.

In various embodiments, parameters of the hearing assistance device are adjusted using the fitting system. Fitting data includes, but is not limited to, one or more of: frequency dependent gain information, acoustic feedback canceller information, noise management information, selectable parameters, mode selection information, and/or other settings for a hearing assistance device. Collectively, fitting data may be considered a hearing assistance device profile.

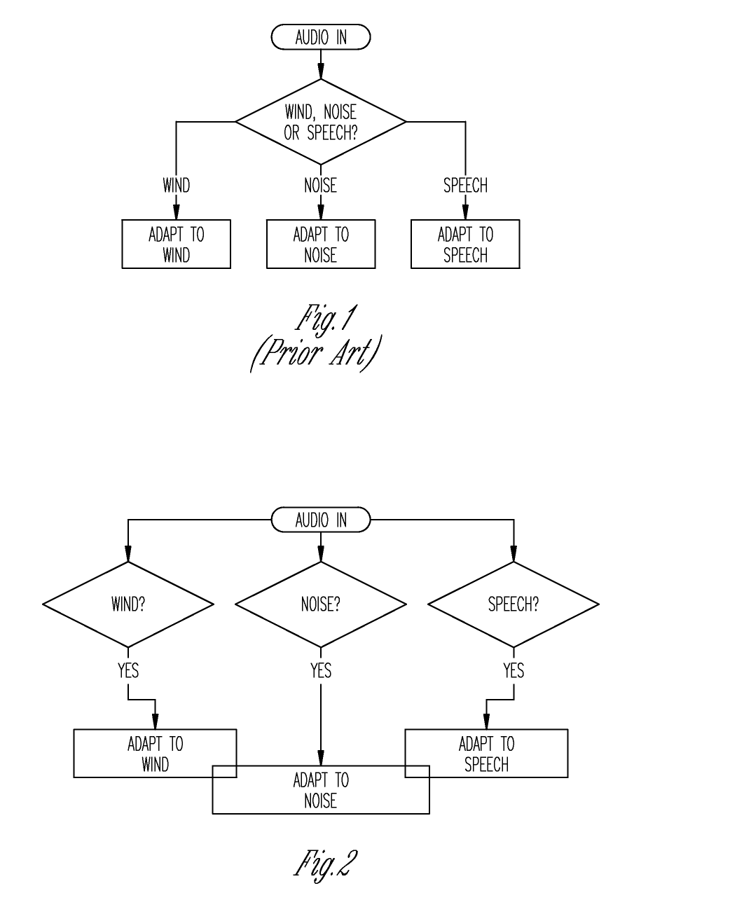

The present subject matter provides, among other things, a general architectural approach that is different in several respects than traditional classification algorithms. In FIG. 1, traditional technology attempts to classify incoming acoustic features into one of three distinct, predefined classes. In contrast, in FIG. 2, the present subject matter uses a string of simultaneous and independent detectors to classify incoming acoustic features. FIG. 2 illustrates one approach for a three-class classifier, however, it is understood that the number may be different than three. The result of the present classification system is that the adaptation phase can adapt more suitably to combinations of acoustic classes or environments. For example, a HA wearer listening to speech in quiet may encounter some intermittent background noise, occasionally including some wind noise if he/she is outdoors. The traditional scheme would enforce predefined adaptation routines for each distinct sound class/environment. That approach is sub-optimal when combinations of sounds/environments are encountered. The traditional approach (of FIG. 1) typically results in an adaptation scheme that might bounce from noise adaption to wind adaptation and would not be able to handle the combination of the two. The new approach (of FIG. 2) will more gracefully adapt from single classes of sounds, adding and/or removing adaptation strategies depending on the individual detectors. In one example, adaptation to noise (HA gains adjustment and noise-reduction algorithm) is joined by wind adaptation (further gain reductions at low frequencies) when wind is encountered.

Various embodiments of the present subject matter provide a system that is independent of the specific underlying classification techniques and adaptation procedures and is an architectural specification wherein the classification system operates as a series of independent environment detectors allowing for layered or combinatorial adaptation strategies.

Alternate implementations include, but are not limited to, traditional discrete-class classifiers coupled with single-class adaptation strategies, as well as single-class detectors with single-class adaptation strategies.

The present subject matter can be used for a variety of hearing assistance devices, including but not limited to, assistive listening devices, tinnitus masking devices, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, such as receiver-in-the-canal (RIC) or receiver-in-the-ear (RITE) designs. It is understood that other hearing assistance devices not expressly stated herein may fall within the scope of the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method of operating a hearing assistance device for a wearer, the method comprising:
receiving acoustic inputs using the hearing assistance device;
determining a plurality of acoustic environments by performing signal processing in parallel based on the received acoustic inputs; and
adjusting an audiological parameter of the hearing assistance device based the determined plurality of acoustic environments using hearing assistance electronics.

2. The method of claim 1, wherein receiving acoustic inputs includes using a series of detectors.

3. The method of claim 1, wherein determining a plurality of acoustic environments includes determining whether the acoustic inputs include speech.

4. The method of claim 1, wherein determining a plurality of acoustic environments includes determining whether the acoustic inputs include noise.

5. The method of claim 1, wherein determining a plurality of acoustic environments includes determining whether the acoustic inputs include wind.

6. The method of claim 1, wherein determining a plurality of acoustic environments includes concurrently determining whether the acoustic inputs include speech, wind and noise.

7. The method of claim 1, wherein adjusting an audiological parameter of the hearing assistance device includes adjusting frequency dependent gain information.

8. The method of claim 1, wherein adjusting an audiological parameter of the hearing assistance device includes adjusting acoustic feedback canceller information.

9. The method of claim 1, wherein adjusting an audiological parameter of the hearing assistance device includes adjusting noise management information.

10. The method of claim 1, wherein adjusting an audiological parameter of the hearing assistance device includes adjusting mode selection information.

11. A hearing assistance system including a hearing assistance device for a wearer, the system comprising:
a plurality of detectors configured to receive acoustic inputs;
a signal processor configured to determine a plurality of acoustic environments in parallel using the acoustic inputs, and to provide settings for the hearing assistance device for improved signal processing in the plurality of acoustic environments; and
a receiver for playing sounds processed by the signal processor.

12. The system of claim 11, wherein the plurality of detectors includes a hearing assistance device microphone.

13. The system of claim 11, wherein signal processor includes a digital signal processor (DSP).

14. The system of claim 11, wherein the hearing assistance device includes a hearing aid.

15. The system of claim 14, wherein the hearing aid includes an in-the-ear (ITE) hearing aid.

16. The system of claim 14, wherein the hearing aid includes a behind-the-ear (BTE) hearing aid.

17. The system of claim 14, wherein the hearing aid includes an in-the-canal (ITC) hearing aid.

18. The system of claim 14, wherein the hearing aid includes a receiver-in-canal (RIC) hearing aid.

19. The system of claim 14, wherein the hearing aid includes a completely-in-the-canal (CIC) hearing aid.

20. The system of claim 14, wherein the hearing aid includes a receiver-in-the-ear (RITE) hearing aid.
